(19) United States
(12) Patent Application Publication
(10) Pub. No.: US 2023/0001318 A1
(43) Pub. Date: Jan. 5, 2023

(54) MOMENTUM WHEEL TOY

(71) Applicant: EXCITE USA, ADDISON, TX (US)

(72) Inventor: Shane Coleman, Upper Hutt (NZ)

(73) Assignee: EXCITE USA, ADDISON, TX (US)

(21) Appl. No.: 17/300,440

(22) Filed: Jul. 1, 2021

(51) Int. Cl. A63H 18/14; A63H 33/26; F21V 23/04; F21V 33/00

(52) U.S. Cl. CPC A63H 18/14; A63H 33/26; F21V 23/0442; F21V 33/008; F21Y 2115/10

(57) ABSTRACT

A momentum wheel toy comprises a track having two track sections and a wheel. The wheel has a ferromagnetic axle positioned through its center, with a first end and a second end that each ride upon a track section. The two track sections are separated by a spacer which separates the walls enough to allow the first end and second end of the ferromagnetic axle to ride on the ferromagnetic strips positioned around the perimeter of each of the first track section and the second track section. A handle opening through the device allows the toy to be rocked back and forth, creating the momentum energy for the wheel to go around the track.

A toy is disclosed which teaches the concept of magnetism versus momentum.

### BRIEF DESCRIPTION OF THE FIGURES

FIG. 1 is a perspective view of the momentum wheel toy;

FIG. 2 is a perspective view of the momentum wheel track;

FIG. 3 is a front side perspective view of the momentum wheel track;

FIG. 4 is a rear underside perspective view of the momentum wheel track with the momentum wheel toy on the track;

FIG. 5 is an exploded view of the momentum wheel track;

FIG. 6 is an alternative embodiment of the spacer;

FIG. 7 is a rear underside view of the momentum wheel track toy;

FIG. 8 is a perspective view of the momentum wheel;

FIG. 9 is a perspective view of the other side of the momentum wheel; and

FIG. 10 is a perspective view of the inside of the momentum wheel without a side.

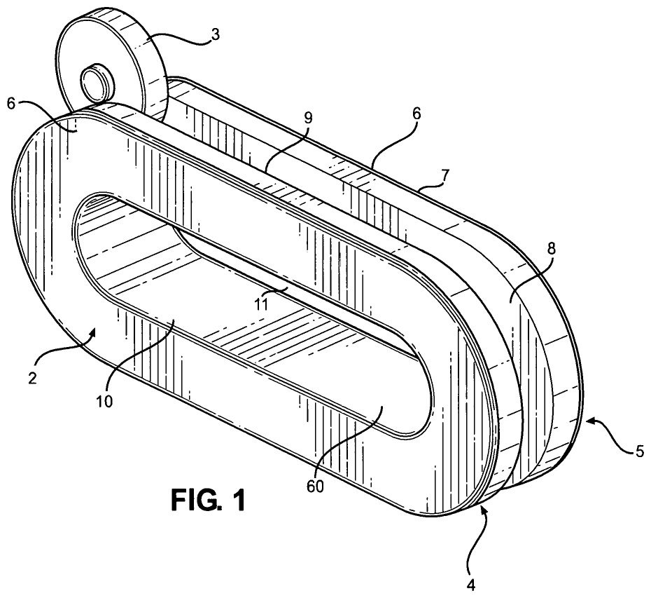

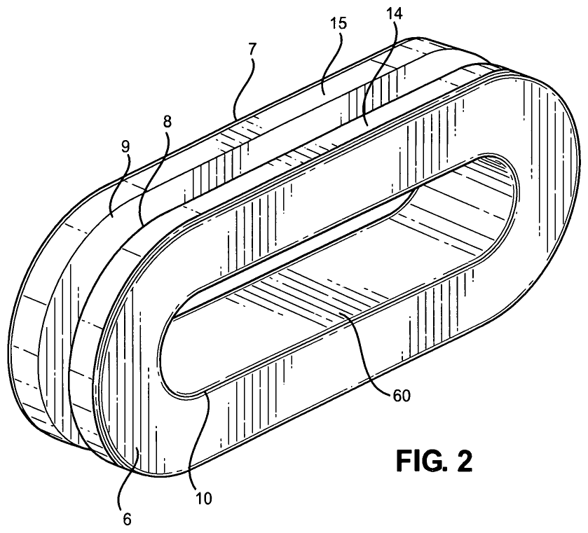

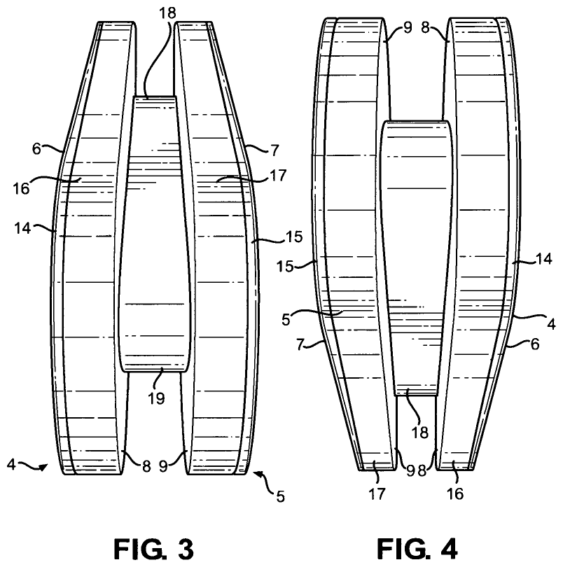

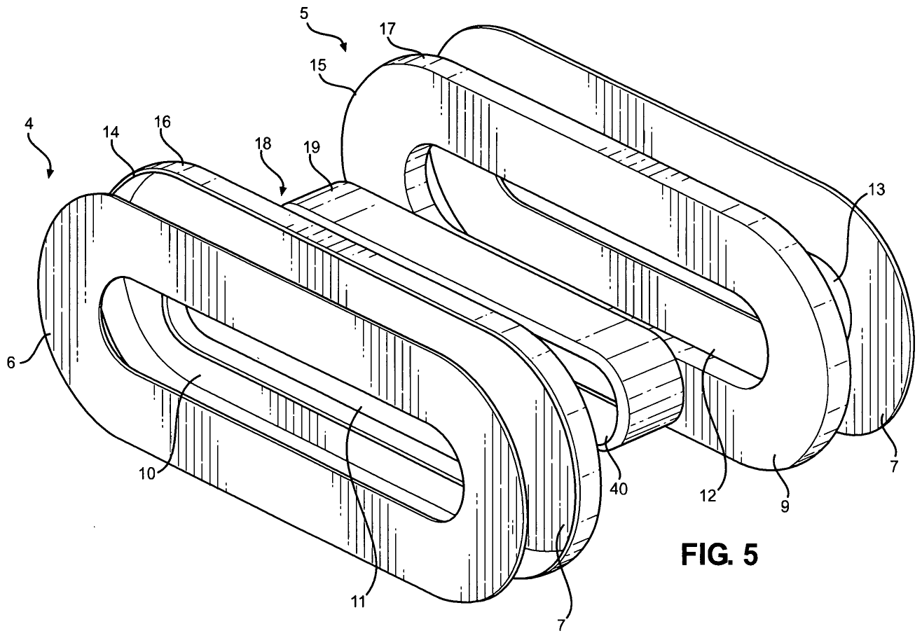

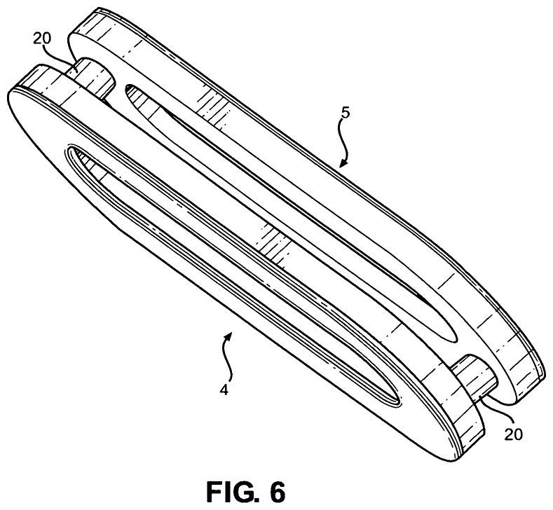

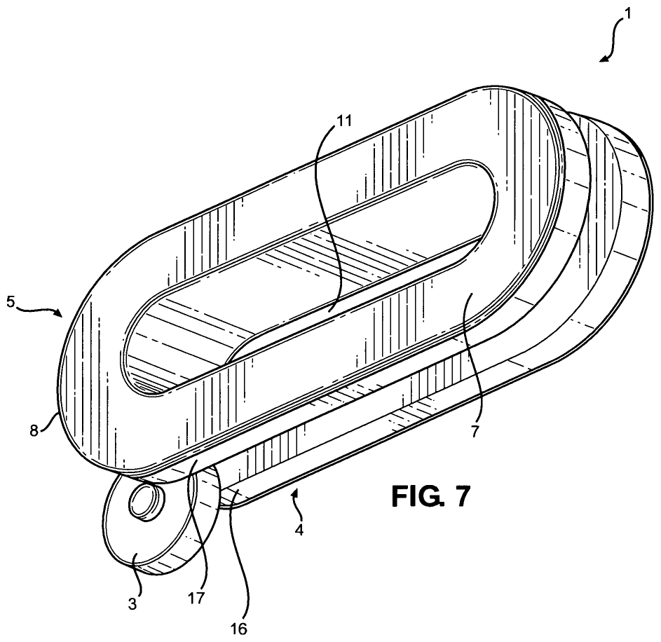

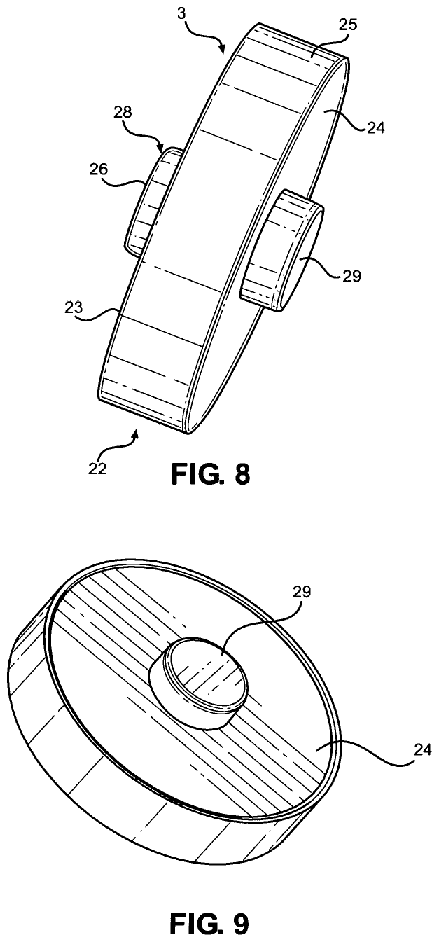

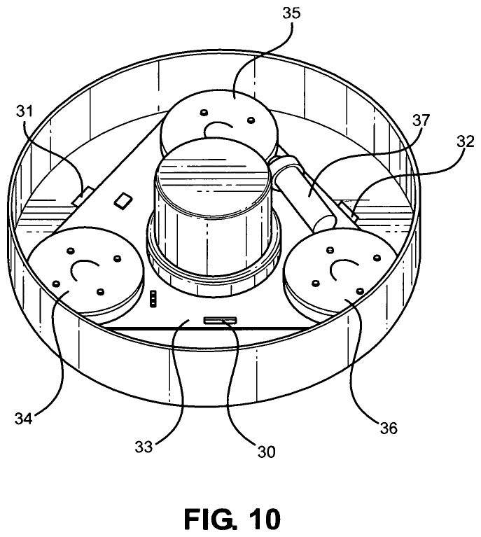

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

### DETAILED DESCRIPTION OF THE DISCLOSURE

The present description is for a momentum wheel toy 1. The momentum wheel toy 1 discloses a track 2 and the momentum wheel. 3.

The track is comprised of two track section 4, 5. Each section 4, 5 has an outer wall 6, 7, and an inner all 8,9. In one embodiment, the outer wall 6 and the inner wall 8 in one section are parallel to each other in one track section 4, and the outer wall 7 and the inner wall 9 are parallel to each other in the other section 5. In another embodiment, both sections 4,5, are parallel to each other. Both of the outer walls 6,7 and the inner walls 8,9 have identical hand opening 10, 11, 12, 13 in them, forming one unitary hand opening 60. In one embodiment, the hand opening 10, 11, 12, 13 are parallel and each hand opening has exactly the same shape. In one embodiment, the hand opening 10, 11, 12, 13 are oval shaped. In another embodiment, the hand opening 10, 11, 12, 13 are round, or circular in shape. In yet another embodiment, the hand opening 10, 11, 12, 13 are polygonal in shape. In another embodiment, the hand opening 10, 11, 12, 13 are large enough such that a child or average sized man (or woman) is able to slip their hand(s) and or fingers through the hand opening 10 so as to have control of the device. Each of the hand opening 10, 11, 12, 13 is centered on their respective outers or inner walls, and all of the hand opening are aligned. In one embodiment, all of the hand opening are parallel.

In one embodiment, the inner and outer walls are made of plastic. In another embodiment, the inner 8, 9 and outer walls 6, 7 are made of wood. In yet another embodiment, the inner 8,9 and outer walls 6, 7 are made of metal and in yet another embodiment, the inner and outer walls are made of a ferromagnetic metal.

In another embodiment, each of the track sections 4, 5 are oval or round. In another embodiment, each of the inner walls 8,9, and outer walls 6,7 are oval, round, or polygonal with rounded corners or edges. The sides sections are identical to each other and the top and bottom sections of the track are identical to each other.

Each of the track sections 4, 5 have an edge or perimeter 14, 15. This edge is measured or extended from the outer perimeter of the outer walls 6, 7, Ito the outer perimeter of the inner wall 8,9.

Each of the edges or perimeters 14, 15 has positioned on top (of the edges) a ferromagnetic strip 16, 17. In another embodiment, the ferromagnetic strips 16, 17 are integral with the edges or perimeters 14, 15 of the track sections 4, 5.

A spacer 18 is positioned between the first track section 4 and the second track section 5. The spacer can be in parallel to and in contact with the inner walls 8,9. In one embodiment, a perimeter of the outer edge 19 of the spacer 18 is similar but smaller than the perimeters 14, 15 of the first track section 4 and the fifth track section 5. In one embodiment there is a hand opening 40 in spacer 18 that is identical to the other described hand opening.

In another embodiment, the spacer is just a block or a series of blocks of any shape. In yet another embodiment, the spacers are separating pipes 20 connecting the two track sections 4,5. In one embodiment none of these spacers

In another embodiment, a momentum wheel 3 rides on the edges/perimeters of the first and second perimeters/edges 14, 15 of the first track section 4 and the second track section 5. More specifically, the momentum wheel 3 comprises a wheel 22. In one embodiment, the wheel 22 is made out of plastic, but in other embodiments, the wheel 22 can be made out of wood or metal. The wheel 3 has a first circular side 23, a second circular side 24, and a circular rim 25 around the two sides at the perimeter of the wheel. In another embodiment, there is one axle 28 going through the center of the first and second sides, with the first axle end 26 exiting through the center of the first side 23 and second axle end 29 exiting through the center of the second side 24. The axle is ferromagnetic and the axle and the ferromagnetic strips 16, 17 are attracted to each other.

The first axle end 26 and the second axle end 29 are each long enough so as to be able magnetically reside on and glide along the ferromagnetic strips 16, 17. In another embodiment, the first axle side 26 and the second axle side 29 are of equal length.

It should be noted that the spacer, in any form, is positioned far enough below the perimeters 14, 15 of track sections 4, 5, so that the axle ends easily ride on the ferromagnetic strips 16, 17. More specifically, the spacer is positioned at least or greater than the distance between the outer surface of the axle end 23, 29 and the rim 25 of the momentum wheel 21.

In another embodiment of the disclosure, one side of the wheel is removable. In yet another embodiment of the disclosure, there are a plurality of light emitting diodes (LEDs) 30, 31, 32 of different colors connected to a circuit board 33. There is at least one, and in another embodiment a plurality of batteries 34, 35, 36 provide the power and a motion activation switch 37 signals the lights to turn on. In one embodiment, the LEDs are blinking when they are on. The flickering nature of these LED's is because light output fluctuates. This fluctuation happens because your dimmable light-emitting diodes are designed to switch on and off at a designated speed.

To work the device, the user places the wheel above the spacer and between the two sections 4, 5, with the two axle sides 26, 29 reside on ferromagnetic strips 16, 17, respectively. Either the axle of the wheel 28 or the ferromagnetic strips 16,17 are magnetic or both are magnetic. The user places his hand through the complete hand opening 50 of the momentum wheel toy 1 whereupon the grasp the far track section 5 with their fingers. The person then starts a consistent back and forth movement in a horizontal or vertical position to start up the momentum of the momentum wheel 21. Either the axle of the wheel 28 or the ferromagnetic strips 16,17 are magnetic or both are magnetic. It becomes a challenge of magnetic force versus momentum to keep the momentum wheel 21 moving around the track at a consistent or faster speed without momentum forcing the wheel off of the track.

Although the disclosure has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of disclosures(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

What is claimed is:

1. A momentum wheel toy comprising:
a) a track, said track comprising:
i) a first track side comprising:
A) a first side outer wall, said first side outer wall having a first side outer hand opening in a middle with the first side outer wall serving as a perimeter wall surrounding said hand opening;
B) a first side inner wall, said first side inner wall having a first side inner hand opening in a middle with the first side inner wall serving as a perimeter wall surrounding said hand opening, said first side outer wall and said first side inner wall being parallel to each other, and said first side outer hand opening and said first side inner hand opening being parallel;
C) a first track section edge positioned at the perimeter of and between and on said first side outer wall and said first side inner wall; and
D) a first track section ferromagnetic strip positioned at the first side track edge;
ii) a second track side comprising:
A) a second side outer wall, said second side outer wall having a second side outer hand opening in a middle with the second side outer wall serving as a perimeter wall surrounding said second side outer hand opening;
B) a second side inner wall, said second side inner wall having a second side inner hand opening in a middle with the second side inner wall serving as a perimeter wall surrounding said hand opening, said second side outer wall and said second side inner side wall being parallel to each other, and said second side outer hand opening and said first side inner hand opening being parallel;
C) a second track section edge positioned at the perimeter of and between and on [said first side outer wall and said first side inner wall; and
D) a second track section ferromagnetic strip positioned at the first side track edge;
b) a spacer positioned between and in contact with said first track section and said second track section,
wherein the hand opening of said first track side, said second track side, and spacer combine to form a hand grip;
c) a momentum wheel, said momentum wheel comprising:
i) a first momentum wheel side;
ii) a second momentum wheel side;
iii) a rim positioned around both of a perimeter of the first momentum wheel side and the second wheel side;
iv) an axle positioned centrally through both the first momentum wheel side and the second momentum wheel side, the axle having a first ferromagnetic axle end extending from said first momentum wheel side and a second ferromagnetic axle end extending from said second momentum wheel side,
wherein each of said first ferromagnetic axle end and said second ferromagnetic axle end have the ability to rest and roll upon both of said first track section ferromagnetic strip and said second track section ferromagnetic strip simultaneously.

2. The momentum wheel toy of claim 1, wherein said first ferromagnetic axle is integrally connected with the second ferromagnetic axle.

3. The momentum wheel of claim 1, wherein each of said first outer side, said second outer side, said first inner side, said second inner side are made of plastic.

4. The momentum wheel of claim 1, wherein each of said first outer side, said second outer side, said first inner side and said second inner side are made of metal.

5. The momentum wheel of claim 1, wherein at least one of said first outer side, said second outer momentum wheel, said first inner side and said second outer side are made of wood.

6. The momentum wheel of claim 1, wherein:
a) said first track section ferromagnetic strip is integral with the first side track edge; and
b) said second first track ferromagnetic strip is integral with the second side track edge.

7. The momentum wheel of claim 1, wherein each of said hand opening of each of said first side walls and said second side walls are oval and parallel and identical to each other.

8. The momentum wheel of claim 1, wherein each of said hand opening of each of said first side walls and each of said hand opening of said second side walls are round and identical and parallel to each other.

9. The momentum wheel of claim 1, wherein each of said hand opening of each of said first side walls and each of said hand opening of said second side walls are polygonal.

10. The momentum wheel of claim 1, wherein there are no geometric angles along ferromagnetic strip.

11. The momentum wheel of claim 1, wherein each of said first side outer wall, said first side inner wall, said second side outer wall, said second side inner wall comprises:
a) a top segment;
b) a bottom segment;
c) a first side inwardly curved segment; and
d) a second side inwardly curved segment.

12. The momentum wheel of claim 1, wherein said top segment and said bottom segment are in the same plane.

13. The momentum wheel of claim 1, further comprising a plastic insert positioned around said handle grip.

14. The momentum wheel of claim 1, wherein said momentum wheel further comprises motion activated light emitting diodes.
